(19) United States
(12) Patent Application Publication
(10) Pub. No.: US 2024/0303610 A1
(43) Pub. Date: Sep. 12, 2024

(54) METHOD FOR MAINTAINING A DELIVERY ROBOT

(71) Applicant: VALEO SYSTEMES D'ESSUYAGE, La Verriere (FR)

(72) Inventors: Frederic GIRAUD, La Verriere (FR); Alexandre FILLOUX, La Verriere (FR)

(73) Assignee: VALEO SYSTEMES D'ESSUYAGE, La Verriere (FR)

(21) Appl. No.: 18/262,652

(22) PCT Filed: Feb. 4, 2022
(86) PCT No.: PCT/EP2022/052745

§ 371 Date: Jul. 24, 2023

(30) Foreign Application Priority Data
Feb. 4, 2021 (FR) 2101053

(51) Int. Cl. G06Q 10/20; B08B 1/14; B08B 3/02; B60S 3/04; G02B 27/00

(52) U.S. Cl. CPC G06Q 10/20; B08B 1/143; B08B 3/02; B60S 3/04; G02B 27/0006

(57) ABSTRACT

A method for maintaining a delivery robot, the delivery robot including a body and at least one sensor provided with at least one optical surface. The method includes positioning of the delivery robot in a parking base and cleaning the delivery robot by means for cleaning the parking base.

The subject of the invention is a method for maintaining a delivery robot.

In a known manner, a delivery robot is an autonomous vehicle, use of which seeks to solve the logistics problem of the so-called final kilometer, i.e. for the transport of parcels over a short distance of approximately a few kilometers.

A vehicle of this type is provided with a large quantity of sensors, such as cameras or Lidars for example, in order to assure the travel of the robot on roads and/or on sidewalks and pedestrian routes, according to the type of robot used. It will be appreciated that it is of primordial importance to avoid any risk of collision with obstacles on the highway, such as potholes, steps, or worse still, people who are on the path of the delivery robot. This is why it is essential to carry out the upkeep of the delivery robot perfectly.

### SUMMARY

The present disclosure improves the situation.

For this purpose, a method is proposed for maintaining a delivery robot, the robot comprising at least one sensor provided with at least one optical surface, the method comprising the following steps:
positioning of the robot in a parking base; and
cleaning of said delivery robot by means for cleaning the parking base.

Thus, thanks to the present invention, it is possible to carry out the upkeep of the delivery robot in an optimal manner, while assuring lengthy autonomy of the robot, since the cleaning means belong to the parking base, and are not on board the robot.

“Optical surface” means a surface which is configured to permit passage of a range of wavelengths for operation of the sensor.

For example, the optical surface is transparent.

For example, the optical surface is a glazed surface.

For example the optical surface is made of glass or plastic.

“Sensor” means any type of device which makes it possible to emit and/or receive data permitting autonomous travel of the delivery robot.

For example, the data which permits the autonomous travel of the sensor are positioning data, speed data, etc.

The at least one sensor can be a camera and/or a Lidar, and/or a position sensor, and/or a speed sensor.

In certain embodiments, the means for cleaning the parking base comprise at least one spray nozzle, with the cleaning step comprising a humidification sub-step in which the spray nozzle sprays a washing product at least on the optical surface of the robot.

For example, the washing product comprises water. For example the washing product comprises soap. For example the washing product comprises a synthetic detergent.

In certain embodiments, the means for cleaning the parking base comprise at least one wiping element, with the cleaning step comprising a wiping sub-step in which the wiping element wipes at least the optical surface.

For example, the wiping element is configured to wipe the optical surface by means of contact. Thus, during the wiping sub-step, the wiping element wipes at least the optical surface by means of contact. For example, the wiping element comprises an arm and a wiping end. The wiping end can comprise at least one absorbent element, such as a textile, for example felt. The wiping end can comprise a wiping blade. The wiping blade can be resiliently deformable, and can comprise rubber or silicon. For example, the wiping element is a roller. For example the wiping element is a flexible textile strip.

The wiping element can be configured to be driven such as to wipe the optical surface. The wiping element can be driven by any type of actuator known to persons skilled in the art, for example an electrical actuator, such as a motor, or a hydraulic actuator, such as a hydraulic jack. For example, the movement of the wiping element is a movement of rotation. For example the movement of the wiping element is a movement of translation.

The course of the wiping element can cover all or part of the optical surface and/or of the delivery robot, in particular the body and/or the wheels of the delivery robot.

For example, the wiping element is configured to wipe the optical surface by means of blowing. Thus, during the wiping sub-step, the wiping element wipes at least the optical surface by means of blowing. For example, the wiping element comprises an air outlet nozzle. The air outlet nozzle can be configured to blow air at least on the optical surface, such as to wipe the optical surface. The air outlet nozzle can be configured to be brought facing the optical surface before the blowing. The air outlet nozzle can be fixed or movable relative to the optical surface during the wiping sub-step, in particular during the wiping of at least the optical surface by blowing.

For example, the spray nozzle and the wiping element are distinct. For example the spray nozzle is fitted on the wiping element. For example the spray nozzle is formed with the wiping element. For example the spray nozzle is positioned in the parking base spaced from the wiping element.

For example the spray nozzle is movable. In particular, the spray nozzle is configured to be displaced facing the optical surface of the delivery robot.

For example the spray nozzle is secured within the parking base.

In certain embodiments, the wiping sub-step takes place after the humidification sub-step.

In certain embodiments, the wiping sub-step is simultaneous with the humidification sub-step.

According to another aspect, the method comprises a step prior to stoppage of the robot in said parking base.

According to another aspect, the cleaning step comprises at least cleaning of said at least one optical surface of the delivery robot.

According to another aspect, the cleaning step comprises only the step of cleaning said at least one optical surface of the delivery robot.

In addition to the aforementioned advantages, these provisions permit saving of cleaning and energy products. These provisions also make possible a rapid cleaning step.

According to another aspect, the cleaning step also comprises a step of cleaning a body of the delivery robot.

In addition to the aforementioned advantages, these provisions permit complete cleaning of the delivery robot, which makes it possible to space out the manual upkeep and maintenance operations of the delivery robot.

For example, during the humidification sub-step, the at least one spray nozzle is configured to spray the cleaning product on the body of the delivery robot and/or on the optical surface and/or on the wheels of the delivery robot.

For example, during the wiping sub-step, the at least one wiping element is configured to wipe the body of the delivery robot and/or the optical surface and/or the wheels of the delivery robot.

The subject of the invention is also a method for carrying out the upkeep of a delivery robot, the robot comprising a body and at least one sensor provided with at least one optical surface, the upkeep method comprising a series of a first and a second cleaning sequences, with the first cleaning sequence comprising the steps according to the maintenance method previously described in accordance with a first variant, and the second sequence comprising the steps of the maintenance method previously described in accordance with a second variant.

These provisions make it possible to obtain all of the advantages cited above, i.e., savings in energy, cleaning products, and time, and at the same time spacing out the manual maintenance operations of the delivery robot.

According to another aspect, the series of the first and second sequences comprises alternation of the first and second sequences.

These provisions make it possible to obtain the advantages cited above.

According to another aspect, the series of the first and second sequences comprises a succession of a plurality of first sequences then of the second sequence.

These provisions make it possible to obtain the advantages cited above.

According to another aspect, the series of the first and second sequences comprises a succession of five to fifteen and preferably ten of the first sequences, then of the second sequence.

These provisions make it possible to obtain the advantages cited above.

The subject of the invention is also a system for implementation of the maintenance method as previously described, wherein the cleaning means are of a size for cleaning at least one optical surface of the delivery robot and/or the body of the delivery robot.

According to another aspect, said at least one washing means extends longitudinally in a direction with a minimal length equal to a size of said at least one optical surface on a plane containing said direction.

It is understood that the parking base comprises the cleaning means.

The present description also relates to a parking base for receipt of a delivery robot, comprising the system according to any one of the characteristics described above.

For example, the parking base comprises a charger for a battery of the delivery robot.

### BRIEF DESCRIPTION OF THE DRAWINGS

Other characteristics, details and advantages will become apparent on reading the following detailed description, and on studying the appended drawings, in which:

FIG. 1 illustrates a side view of a delivery robot to which the maintenance method according to the present invention can be applied.

FIG. 2 illustrates a front view of the delivery robot of [FIG. 1].

FIG. 3 illustrates a side view of the delivery robot of [FIG. 1] during cleaning according to the maintenance method of a first variant embodiment of the present invention.

FIG. 4 illustrates a front view of the robot of [FIG. 3].

FIG. 5 illustrates a side view of the delivery robot of [FIG. 1] during cleaning according to the maintenance method of a second variant embodiment of the present invention.

FIG. 6 illustrates a front view of the robot of [FIG. 5].

FIG. 7 illustrates a schedule of a maintenance method according to the present invention implemented in FIGS. 3 to 6.

### DESCRIPTION OF THE EMBODIMENTS

In the figures, a reference system (X, Y, Z) has been illustrated in order to simplify the description of the delivery robot and the methods according to the present invention. The direction X corresponds to a direction of advance of the robot during its travels. The direction Y corresponds to a transverse direction of the robot. The direction Z corresponds to a vertical direction.

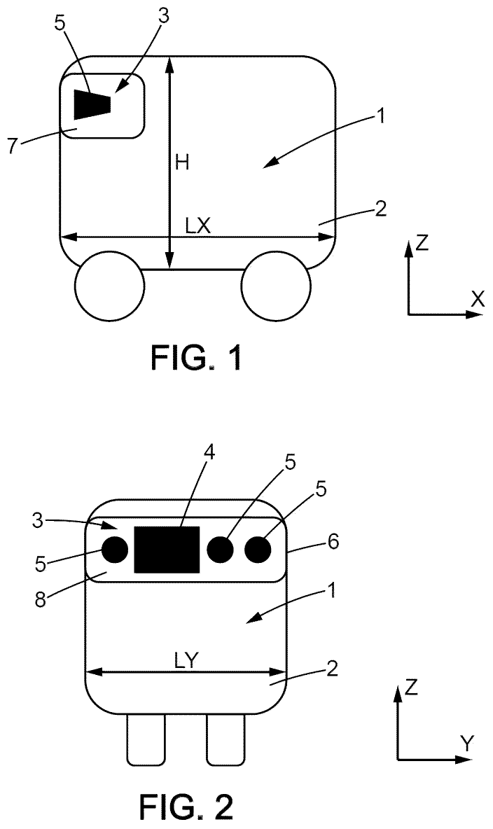

Reference is made firstly to FIGS. 1 and 2 in which a delivery robot 1 is illustrated.

The robot 1 is an autonomous vehicle which provides delivery of parcels over a few kilometers. In a known manner, reference is made to logistics of the final kilometer. The parcel can be of any type, such as, for example, food or a set of books, toys, etc.

The robot 1 has dimensions which are strictly smaller than those of a bus or an autonomous automobile. Preferably, but in a non-limiting manner, the robot 1 has the following dimensions: length LX (parallel to the direction X) of between 30 cm and 1.50 m; width LY (parallel to the direction Y) of between 30 cm and 60 cm; height H (parallel to the direction Z) of between 30 cm and 70 cm.

The robot 1 is configured to travel at low speeds, for example lower than 15 km/h, for example lower than 10 km/h; preferably lower than 5 km/h or 4 km/h.

As is apparent from FIGS. 1 and 2, the robot 1 is provided with a body 2 and a set of driving-assistance sensors 3. In the figures, a Lidar 4 and three cameras 5 are represented as sensors 3.

It should be noted that “Lidar” is an acronym standing for “light detection and ranging” or “laser detection and ranging”. In other words, in this case, the Lidar 4 corresponds to a device which can detect and estimate distance.

The robot 1 comprises an optical surface 6 at the front of the robot 1 which is associated with the set of sensors 3. The optical surface 6 comprises two portions 7 on opposite planes (X, Z) and a portion 8 on a plane (Y, Z). It will be appreciated that this arrangement is non-limiting, and the robot 1 can comprise one or a plurality of optical surfaces positioned on some planes or each plane (X, Y), (Y, Z), (X, Z), Similarly, a given optical surface can be associated with a plurality of sensors 3, or on the contrary dedicated to a single sensor 3.

The robot 1 is configured to return to a parking base 9 between two delivery missions. The parking base 9 advantageously makes it possible to store and recharge the robot 1 when the battery has become run down. The parking base 9 also comprises a system for implementation of the methods according to the present invention, and will be described further hereinafter.

The invention relates to a method for maintenance of the robot 1, as well as to an associated upkeep method, which will now be described.

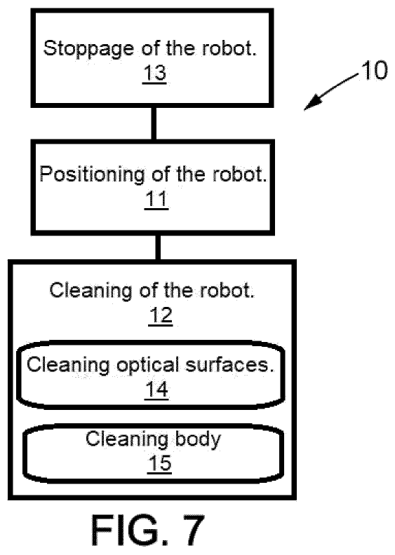

As illustrated in [FIG. 7], the maintenance method 10 comprises the following steps:
positioning 11 of the robot 1 in the parking base 9; and
cleaning 12 of the robot by a means for cleaning of the parking base 9 described hereinafter.

The positioning step 11 is advantageously preceded by a step 13 of stoppage of the robot 1 in the parking base 9.

During the cleaning step 12, at least each optical surface 6 of the robot 1 is intended to be cleaned.

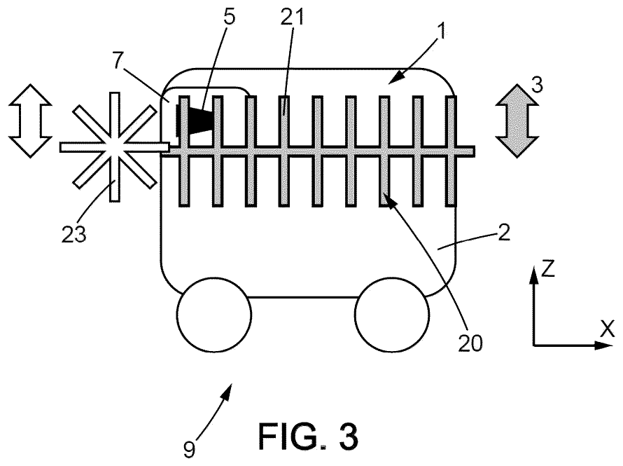

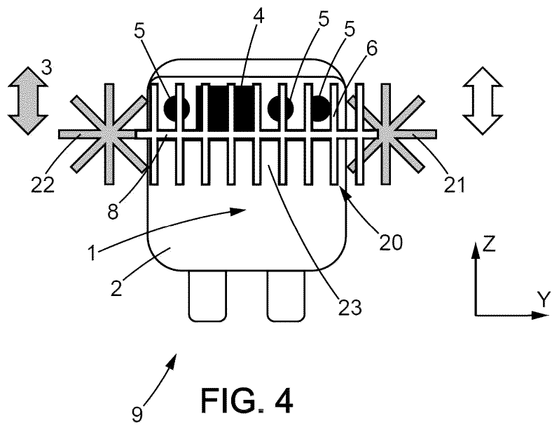

According to a first variant embodiment of the method 10, illustrated in FIGS. 3 and 4, the cleaning step 12 consists of partial cleaning, with the reference 14, comprising at least cleaning of each optical surface 6 of the robot 1.

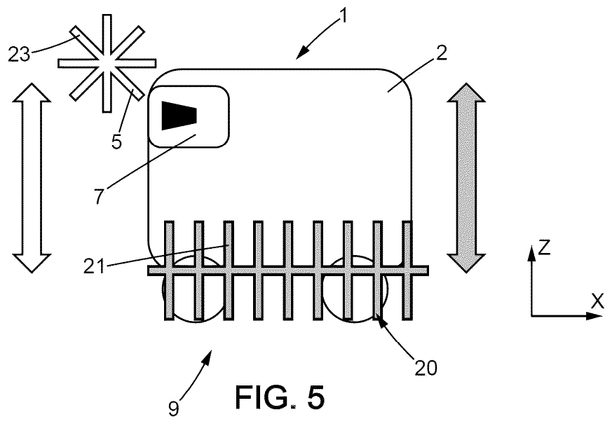

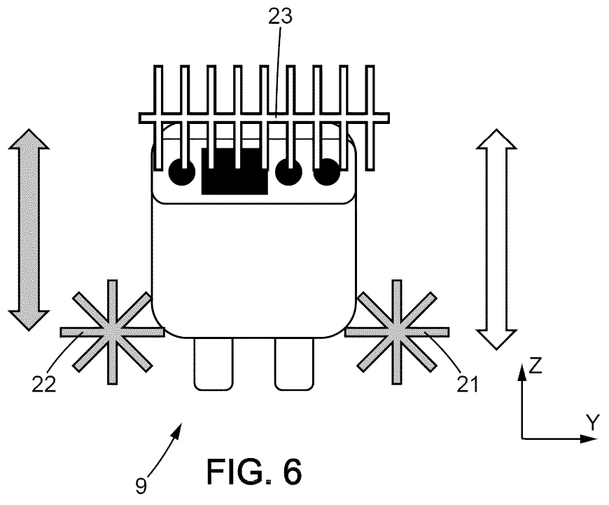

According to a second variant embodiment of the method 10, illustrated in FIGS. 5 and 6, the cleaning step 12 consists of complete cleaning of the robot, with the reference 15, comprising, in addition to cleaning of each optical surface 6, cleaning of the body 2, or also cleaning of the wheels.

The invention also relates to a method for upkeep of the delivery robot 1. The upkeep method consists of a combination of the two variants of the maintenance method.

The upkeep method comprises a series of a first and a second cleaning sequences, with the first cleaning sequence comprising the steps 11 and 14, and the second sequence comprising the steps 11 and 15.

In other words, the first sequence permits partial cleaning of the robot 1, substantially of the optical surfaces 6, whereas the second sequence permits complete cleaning of the robot 1.

According to a first variant, the series of the first and second sequences comprises alternation of the first and second sequences. In this case, one time out of two, only the optical surfaces are cleaned, and, one time out of two, the optical surfaces and the body are cleaned.

According to a second, preferred variant, the series of the first and second sequences comprises a succession of a plurality of first sequences then the second sequence. In this case, several times in succession, only the optical surfaces are cleaned, before proceeding with cleaning of the body in addition to the optical surfaces.

Advantageously, the second variant comprises a succession of five to fifteen, and preferably ten first sequences, then the second sequence.

The invention also relates to a cleaning system for implementation of the maintenance method and the upkeep method.

As shown in the figures, the system 20 comprises the cleaning means comprising in this case, in particular, a set of cleaning rollers.

According to an embodiment not illustrated, the system 20 comprises sprinklers or any other appropriate cleaning means known to persons skilled in the art.

In FIGS. 3 to 6, the set of rollers comprises an opposite pair of rollers 21, 22, a longitudinal axis of which extends parallel to the direction X. The set of rollers also comprises a transverse roller 23, a longitudinal axis of which extends parallel to the axis Y.

The rollers 21, 22, 23 are driven with at least a movement of vertical translation (illustrated by arrows in FIGS. 3 to 6), but they can also be driven with more complex movements, depending on the form of the robot 1, and their positioning relative to the robot in particular.

The rollers 21, 22, 23 have a size suitable for cleaning the robot 1.

The rollers 21 and 22 have a minimal length which is equal to the length of the portion 7 of the optical surface 6. In FIGS. 3 to 6, the length is equal to the length LX of the robot 1.

Advantageously, each roller 21, 22 has a length of between 20 cm and 2 m, preferably between 30 cm and 1.50 m.

The roller 23 has a minimal length which is equal to the length of the portion 8 of the optical surface 6. In FIGS. 3 to 6, the length is equal to the width LY of the robot 1.

Advantageously, the roller 23 has a length of between 20 cm and 80 cm, preferably between 30 cm and 60 cm.

The cleaning system 20 also comprises a tank of cleaning product comprising water and soap or a synthetic detergent (not illustrated). The system 20 also comprises nozzles for spraying the cleaning product.

In FIGS. 3 and 4, according to the first variant of the maintenance method 10, the rollers 21, 22 are positioned along the flanks (X, Z) of the robot 1, whereas the roller 23 is positioned facing the front of the robot 1 on a plane (Y, Z).

The rollers 21, 22 are translated vertically at least up to a height equal to the height of the portion 7 of the optical surface 6. At the most, the rollers 21, 22 are translated vertically from the top of the robot 1 as far as the edge of the portion 8 of the optical surface 6. The roller 23 is translated vertically at least up to a height of the optical surface 8. At the most, the roller 23 is translated vertically from the top of the robot 1 as far as the edge of the portion 7 of the optical surface 6.

During the cleaning, the cleaning product is sprayed on the robot 1, then the movement of translation of the rollers 21, 22, 23 on the height of the optical surface 6 assures the cleaning of the portions 7 and 8 of the optical surface 6.

In FIGS. 5 and 6, according to the second variant of the maintenance method 10, the rollers 21 and 22 are positioned along the flanks (X, Z) of the robot 1, whereas the roller 23 is positioned facing the front of the robot 1 on a plane (Y, Z).

Each of the rollers 21, 22, 23 is translated vertically along the entire height H of the robot 1.

During the cleaning, the cleaning product is sprayed on the robot 1, then the movement of translation along the entire height of the robot assures the cleaning of the optical surface 6, the body 2 and the wheels of the robot 1.

It will be appreciated that the invention is not limited to the arrangement illustrated, and it is possible for example to provide an additional roller which is designed to clean the rear of the robot 1.

The maintenance method 10 according to the present invention has many advantages. In particular, the cleaning in the parking base 9 makes it possible not to put the cleaning means on board the robot 1, which lightens the structure of the robot 1, and simplifies its assembly. The lightening of the structure assures lengthier autonomy of the robot 1, whereas the simplification of assembly represents a saving in time and cost.

It should be noted that the cleaning at the parking base according to the present invention makes it possible in particular to remove dust, insects and mud adhering to the robot 1.

It is also possible to combine the cleaning of dust, insects and mud according to the present invention with simplified and lightened on-board cleaning which, for its part, makes it possible to target the cleaning against traces of rainwater and snow.

In addition, the alternation at a predefined frequency of the sequences of partial cleaning, substantially of the optical surface, and complete cleaning, makes it possible to save water, while assuring that the robot 1 is always clean.

The optimal cleaning of the optical surfaces 6 by means of the method 10 is a safety guarantee, since the sensors can operate well only if the optical surface is transparent. The optimal cleaning of the body 2 thanks to the method 10 for its part makes it possible to create a good image of the brand, and better visibility of any text written on the body 2 of the robot 1.

What is claimed is:

1. A method for maintaining a delivery robot, the delivery robot including at least one sensor provided with at least one optical surface, the method comprising:
positioning of the delivery robot in a parking base; and
cleaning of the delivery robot by a means for cleaning the parking base.

2. The maintenance method as claimed in claim 1, wherein the means for cleaning the parking base includes at least one spray nozzle, with the cleaning includes a humidification process in which the spray nozzle sprays a washing product at least on the optical surface of the robot.

3. The maintenance method as claimed in claim 2, wherein the means for cleaning the parking base includes at least one wiping element, with the cleaning including a wiping process in which the wiping element wipes at least the optical surface.

4. The maintenance method as claimed in claim 3, wherein the wiping process takes place after the humidification process.

5. The maintenance method as claimed in claim 1, wherein the cleaning includes at least cleaning of the at least one optical surface of the delivery robot.

6. The maintenance method as claimed in claim 5, wherein the cleaning includes only cleaning the at least one optical surface of the delivery robot.

7. The maintenance method as claimed in claim 3, wherein the cleaning also includes cleaning a body of the delivery robot.

8. A method for upkeep of a delivery robot, the robot including a body and at least one sensor provided with at least one optical surface, the upkeep method comprising a series of a first and a second cleaning sequences, the first cleaning sequence includes a humidification process in which a spray nozzle sprays a washing product at least on the optical surface of the robot and a wiping process in which a wiping element wipes at least the optical surface, and the second sequence includes cleaning the body of the delivery robot.

9. The method as claimed in claim 8, wherein the series of the first and second sequences comprises alternation of the first and second sequences.

10. The method as claimed in claim 8, wherein the series of the first and second sequences comprises a succession of a plurality of first sequences then of the second sequence.

11. A system for implementation of a maintenance method, comprising a cleaning means of a size for cleaning at least one optical surface of a delivery robot and the body of the delivery robot.

12. The system as claimed in claim 11, wherein the cleaning means extend longitudinally in a direction with a minimal length equal to a size of the at least one optical surface on a plane containing the direction.

13. The system as claimed in claim 11, further comprising a parking base for receipt of the delivery robot.
